(19) United States
(12) Patent Application Publication
(10) Pub. No.: US 2006/0012992 A1
(43) Pub. Date: Jan. 19, 2006

(54) LED luminance enhancing construction

(75) Inventor: Ming-Shun Lee, Taipei (TW)

Correspondence Address: TROXELL LAW OFFICE PLLC;SUITE 1404, 5205 LEESBURG PIKE, FALLS CHURCH, VA, 22041, US

(73) Assignee: Taiwan Oasis Technology Co., Ltd.

(21) Appl. No.: 10/890,099

(22) Filed: Jul. 14, 2004

(51) Int. Cl. F21V 7/00

(52) U.S. Cl. 362/237; 362/243; 362/297

(57) ABSTRACT

A construction to enhance luminance of a light emitting diode having a bowl reflector disposed to a carrier of the LED; a chip as the light source being disposed at the center of the bottom of the reflector; multiple reflection blocks surrounding the inner layer of the bowl reflector; each reflection block comprised of multiple transitional reflection surfaces from the bottom towards the top edge of the bowl reflector; and each transitional reflection surface focusing light source from each part of the chip to project the light into the area above the chip to enhance the LED luminance.

### BACKGROUND OF THE INVENTION

(a) Field of the Invention

The present invention is related to an improved construction of a light emitting diode (LED), and more particularly, to one that enhances the lamination results for the LED.

(b) Description of the Prior Art

The LED generally available in the market for giving features of being compact, low power consumption, lower heat generated and longer service life have been gradually exiting the conventional tungsten lamps in the adaptation to commodities such as Christmas decoration lights, flash lights, vehicle signal lamps, and traffic signs. The LED is essentially comprised of a see-three packaging containing conductors of different polarities and a carrier. A chip is fixed to the carrier, and a golden plated wire connects an electrode layer of the chip to the conductor while each conductor extends out of the transparent packaging to serve as a contact to the power source.

Accordingly, when the conductor is conducted, the light source generated by the chip emits the light. A fluorescent material may be provided to the peripheral of the chip so that when the light source generated from the chip penetrates the fluorescent material, the wavelength of the source light is incorporated with that of the fluorescence material to produce the light color expected. With improved manufacturing process and workmanship, the LED may be designed to emit a specific light color depending on the type of fluorescent material used to further expand the application range of the LED in the market. However, current R&D efforts for the LED are essentially invested in the color performance results and the increase of the production capacity of the LED. Therefore, there has been so far the absence of seeing any breakthrough in enhancing the luminance of the LED.

### SUMMARY OF THE INVENTION

The primary purpose of the present invention is to provide a construction for enhancing the luminance of a light emitting diode. To achieve the purpose, the LED is related to a transparent packaging containing conductors of different polarities and a carrier. A chip and a fluorescence material are fixed to the carrier; and a golden plated wire connects the electrode layer of the chip and the conductors. A bowl reflector is disposed to a carrier of the LED and a chip as the light source is disposed at the center of the bottom of the reflector. Multiple reflection blocks surround the inner layer of the bowl reflector with each reflection block comprised of multiple transitional reflection surfaces from the bottom towards the top edge of the bowl reflector. Accordingly, each transitional reflection surface focuses light source from each part of the chip to project the light into the area above the chip.

### BRIEF DESCRIPTION OF THE DRAWINGS

FIG. 1 is a schematic view showing a construction of a light emitting diode of a first preferred embodiment of the present invention.

FIG. 2 is an exploded view showing a chip and a reflector in the first preferred embodiment of the present invention.

FIG. 3 is a schematic view showing the reflection status of the light source from each part of the chip in the first preferred embodiment of the present invention.

FIG. 4 is a schematic view showing a construction of a light emitting diode of a second preferred embodiment of the present invention.

### DETAILED DESCRIPTION OF THE PREFERRED EMBODIMENTS

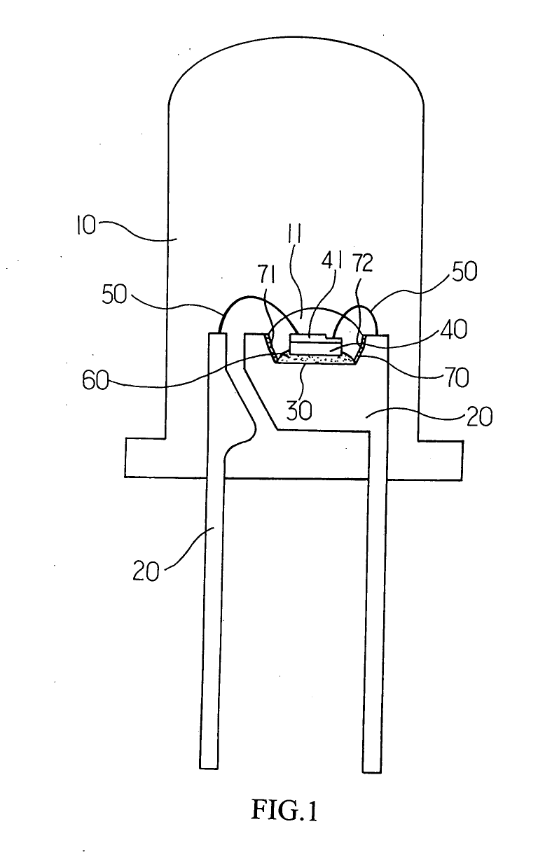

Referring to FIG. 1 for the basic construction of a light emitting diode, the LED is comprised of a transparent packaging 10 containing conductors 20 of different polarities and a carrier 30. A chip 40 and a fluorescent material 60 are fixed to the carrier 30. The conductor 20 is connected to the electrode layer 41 of the chip 40 by a golden plated wire 50. Each conductor 20 extends out of the transparent packaging 10 to serve as a contact for the power supply.

Accordingly, when the conductor 20 is conducted, the light generated from the chip 40 passes through the fluorescent material 60, wherein, the wave length of the source light is incorporated with that of the fluorescent material 60 to emit the light color expected.

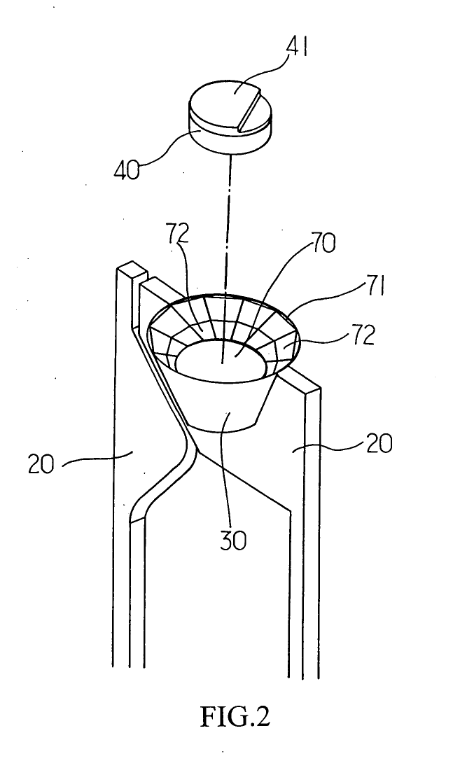

As illustrated in FIG. 2, a reflector 70 is further provided at where between the carrier 30 and the chip 40. In a first preferred embodiment of the present invention, the carrier 30 in a bowl structure is provided on one conductor 20 and the reflector also in a blow structure is fixed to the carrier 30. The chip 40 is fixed to the center at the bottom of the reflector 70. The fluorescent material 60 relates to an admixture comprised of the adhesive material used to fix the chip 40 to the reflector 70 and fluorescent powders so to apply between the chip 40 and the reflector 70 to forthwith adhere the chip 40 to the reflector 70.

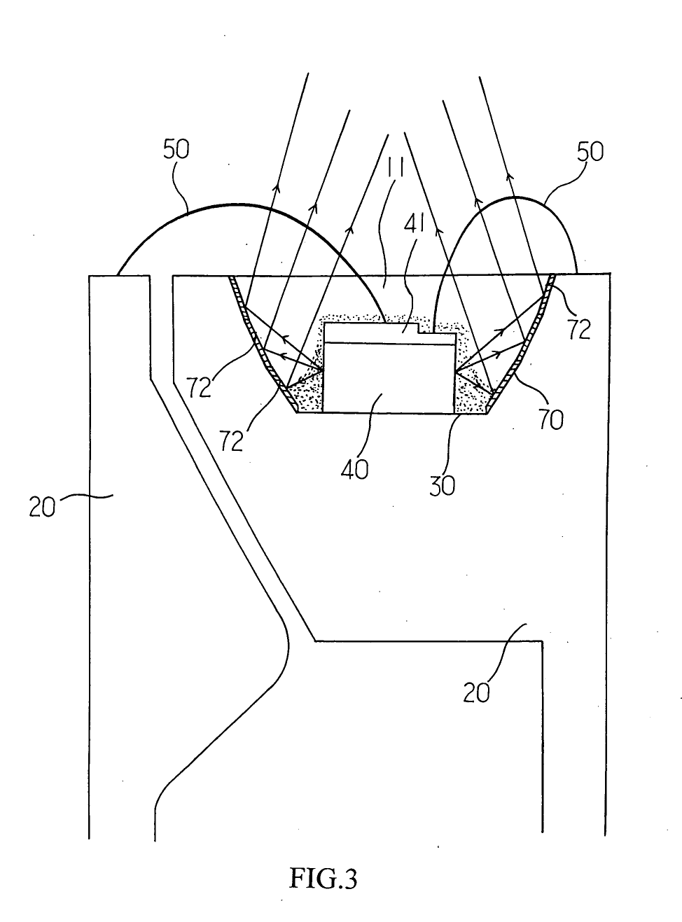

Multiple reflection blocks each in fan-shaped surround in radius the inner layer of the bowl of the reflector 70. Each reflection block 71 is patched up with multiple transitional reflection surfaces 72 from the bottom towards the top edge of the bowl reflector 70. In the first preferred embodiment of the present invention, each sector of those reflection blocks 71 is patched up with multiple transitional reflection surfaces 72 each in the form a glass mirror to surround the bowl reflector 70. A reflection surface is thus formed in the inner layer of the reflector 70 by multiple transitional reflection surfaces 72 respectively at a given height and angle for each transitional reflection surface 72 to focus the light source form each part of the chip 40 and project the light into the area above the chip 40 to effectively increase the luminance of the LED as illustrated in FIG. 3.

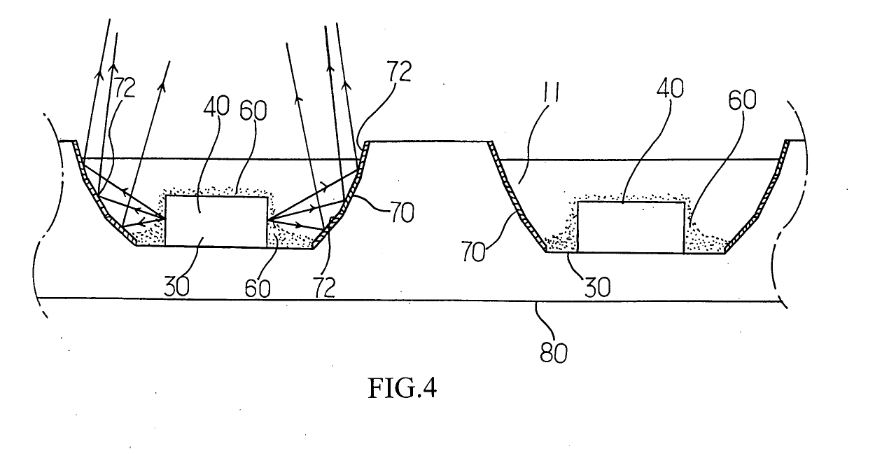

The type of the fluorescent material 60 may vary depending on the spatial structure and manufacturing process of the LED. For the first preferred embodiment illustrated in FIG. 1, transparent insulation glue 11 is formed on the surface of the chip as demanded by the manufacturing process of the LED. Furthermore, as illustrated in FIG. 4 for a second preferred embodiment of the present invention, the LED is directly constructed on a circuit board 80. A recessed carrier 30 is preset on the circuit board 80 with the reflector 70 fixed at the bottom inside the carrier and each conductor (not illustrated) is directly arranged on the contact of the circuit board 80.

In the second preferred embodiment of the present invention, the fluorescent material 60 comprised of transparent insulation glue and fluorescent powders are filled into the carrier 30, then baked and hardened. The fluorescent material 60 due to its central gravity consistently caps on the surface of the chip 40 with the transparent insulation glue on top to become crystal clear insulator 11 to directly cap on the utmost top layer of the chip 40 to protect the chip 40.

The present invention provides an improved construction of a light emitting diode to effectively enhance its luminance, and this application for a utility patent is duly filed. However, it is to be noted that that those preferred embodiments disclosed in the specification and the accompanying drawings are in no way limiting the present invention. Therefore, any construction, installation, or characteristics that is same or similar to that of the present invention should fall within the scope of the purposes and claims of the present invention.

1. A light emitting diode luminance enhancing construction having a transparent packaging containing conductors of different polarities and a carrier; a chip being fixed to the carrier; a golden plated wire connecting both electrode layer of the chip and the conductors; a bowl reflector being disposed at the carrier; the chip being provided at the center of the bottom of the reflector; multiple reflection blocks surrounding the inner layer of the reflector; each reflection block comprised of multiple transitional reflection surfaces from the bottom towards the top edge of the reflector; and all the transitional reflection surfaces focusing light source from each part of the chip to project into the area above the chip to enhance LED luminance.

2. The light emitting diode luminance enhancing construction of claim 1, wherein, each of those reflection blocks surrounding in radius the inner layer of the blow reflector indicates a shape of a sector.

3. The light emitting diode luminance enhancing construction of claim 1, wherein, the reflector is pasted up with multiple reflection blocks.

4. The light emitting diode luminance enhancing construction of claim 1, wherein, each reflection block is pasted up with multiple transitional reflection surfaces.

5. The light emitting diode luminance enhancing construction of claim 3, wherein, the reflection block is made of glass mirror.

6. The light emitting diode luminance enhancing construction of claim 4, wherein, each transitional reflection surface is made of glass mirror.
